(19) United States
(12) Patent Application Publication
(10) Pub. No.: US 2020/0342477 A1
(43) Pub. Date: Oct. 29, 2020

(54) INFORMATION PROCESSING APPARATUS AND METHOD OF MONITORING COMPONENT INFORMATION

(71) Applicant: FUJITSU LIMITED, Kawasaki-shi (JP)

(72) Inventors: Yoshihiko MURAKAWA, Yokohama (JP); Akira KATSUNO, Kawasaki (JP); Tatsuya Yamamoto, Kawasaki (JP)

(73) Assignee: FUJITSU LIMITED, Kawasaki-shi, Kanagawa (JP)

(21) Appl. No.: 16/855,017

(22) Filed: Apr. 22, 2020

(30) Foreign Application Priority Data
Apr. 26, 2019 (JP) 2019-085971

(51) Int. Cl. G06Q 30/02; G06Q 10/06; G05B 23/02

(52) U.S. Cl. CPC G06Q 30/0206; G05B 23/0283; G06Q 10/06315

(57) ABSTRACT

A non-transitory computer-readable recording medium has stored therein a program that causes a computer to execute a process, the process inducing: acquiring, from a plurality of sites which sell a plurality of components, a unit price of a component sold on each of the plurality of sites repetitively at different time points; and issuing a notification when a standard deviation of respective unit prices of a target component on the plurality of sites exceeds a prescribed value.

### CROSS-REFERENCE TO RELATED APPLICATION

This application is based upon and claims the benefit of priority of the prior Japanese Patent Application No. 2019-85971, filed on Apr. 26, 2019, the entire contents of which are incorporated herein by reference.

### FIELD

The embodiments discussed herein are related to an information processing apparatus and a method of monitoring component information.

### BACKGROUND

Heretofore, manufacturers have been carrying out component procurement from venders offering low unit prices through the Internet and the like.

For such component procurement, it is desirable to conduct sufficient study in advance as to whether or not stable component supply will be continuously received. This is because there is a risk of design change and so forth when facing a stoppage (or temporary suspension) of component supply due to the occurrence of any of various events such as an end of life (EOL). As used herein, EOL refers to when a component, from the perspective of a vendor/manufacturer, has been determined to have reached the end of its useful lifespan. After this period or particular date, the vendor/manufacturer will no longer market, sustain, and/or, sell the product.

To address this, for example, an apparatus that makes monitoring for the occurrence of an EOL on the Internet has been proposed.

Related techniques are disclosed in, for example, Japanese Laid-open Patent Publication No. 7-282137, Japanese Laid-open Patent Publication No. 2012-252678, and Japanese Laid-open Patent Publication No. 2007-87276.

### SUMMARY

According to an aspect of the embodiments, a non-transitory computer-readable recording medium has stored therein a program that causes a computer to execute a process, the process including: acquiring, from a plurality of sites which sell a plurality of components, a unit price of a component sold on each of the plurality of sites repetitively at different time points; and issuing a notification when a standard deviation of respective unit prices of a target component on the plurality of sites exceeds a first prescribed value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a component information monitoring system;

FIG. 2 is a diagram illustrating an example of a hardware configuration of a component information monitoring apparatus;

FIG. 3 is a first diagram illustrating an example of a functional configuration of the component information monitoring apparatus;

FIG. 4 is a diagram illustrating a specific example of component unit prices and standard deviations;

FIGS. 5A and 5B are diagrams illustrating an example of determination of a standard deviation threshold;

FIGS. 6A to 6C are diagrams illustrating an example of determination of a decrease rate threshold, an out-of-stock rate threshold, and a discount display count threshold;

FIG. 7 is a diagram illustrating an example of criteria information;

FIG. 8 is a diagram illustrating an example of analysis results by an analysis unit;

FIG. 9 is a flowchart illustrating a procedure of criteria determination processing;

FIG. 10 is a flowchart illustrating a procedure of component information monitoring processing;

FIG. 11 is a second diagram illustrating an example of a functional configuration of the component information monitoring apparatus;

FIG. 12 is a diagram illustrating an example of standard deviation variation amounts; and

FIG. 13 is a third diagram illustrating an example of a functional configuration of the component information monitoring apparatus.

### DESCRIPTION OF EMBODIMENTS

It is not easy to make monitoring for the occurrences of all of various events including events other than an EOL on the Internet. Meanwhile, for the component procurement, a component having a risk of design change such as a component on which some event has already occurred or a component on which some event is likely to occur is desirably excluded in advance from procurement targets.

Hereinafter, the embodiments will be described with reference to the accompanying drawings. In the present specification and drawings, constituent elements having substantially the same functional configuration are denoted with the same reference sign and the repetitive description thereof is omitted.

### First Embodiment

<Configuration of Component Information Monitoring System>

First, a configuration of a component information monitoring system will be described. The component information monitoring system is a system that indirectly monitors a target component under component procurement in terms of the occurrence of some event or the possibility of some event occurring (this information will be referred to as “component information”) from multiple viewpoints.

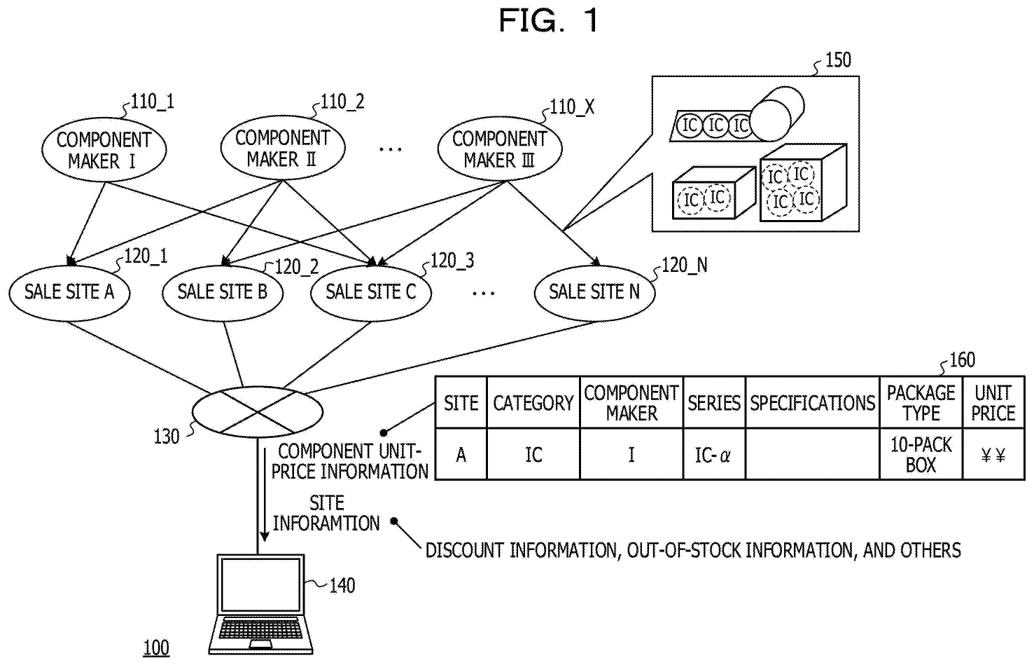

FIG. 1 is a diagram illustrating a configuration example of a component information monitoring system. As illustrated in FIG. 1, a component information monitoring system 100 includes a component maker 110_1 (maker name: “Component Maker I”) to a component maker 110_X (maker name: “Component Maker X”). The component information monitoring system 100 includes a sale site 120_1 (site name: “Sale Site A”) to a sale site 120_N (site name: “Sale Site N”). The component information monitoring system 100 includes a component information monitoring apparatus 140. The component information monitoring apparatus 140 is coupled to the sale sites 120_1 to 120_N through a network 130 so as to be able to access the sale sites 120_1 to 120_N.

The component makers 110_1 to 110_X are makers that produce components to be incorporated into products manufactured by a user (manufacture) of the component information monitoring apparatus 140 and supply the components to the user. In the first embodiment, components produced by the component makers 110_1 to 110_X are electronic components.

The electronic components mentioned herein include, for example, integrated circuits (ICs), memories, resistance elements, coil elements, and so on. The electronic components may also include microprocessors, inverters, field-programmable gate arrays (FPGA), inductors, connectors, capacitors, switching elements, transistors, filters, and so on.

Each of the component makers 110_1 to 110_X supplies the electronic components to users through venders which operate their respective sale sites 120_1 to 120_N. In FIG. 1, reference sign 150 indicates an example of electronic components to be supplied to the venders by the component makers 110_1 to 110_X (in a category=“IC” in the example of FIG. 1).

As illustrated with reference sign 150, various packaging types are used by the component makers 110_1 to 110_X to supply electronic components to the venders, and include a type in which electronic components are arrayed on a tape-form member, a type in which electronic components are boxed, and so on. In the case of boxed electronic components, boxes in any size are used.

The sale sites 120_1 to 120_N are sites operated by the venders which sell the electronic components supplied by the component makers 110_1 to 110_X. The sale sites 120_1 to 120_N display the unit prices of the electronic components decided by the venders. In the case where a vender sells various packaging types of electronic components in various series of various categories by various component makers, the sale site displays the unit price decided for each component maker, each category, each series, and each packaging type.

The sale sites 120_1 to 120_N also display discount information when the venders sell the electronic components at discount prices. The sale sites 120_1 to 120_N also display out-of-stock information when the venders run out of stock. Hereinafter, the discount information, the out-of-stock information, and others displayed on the sale sites 120_1 to 120_N are collectively referred to as site information.

The component information monitoring apparatus 140 acquires component unit-price information and the site information of each of the electronic components by accessing each of the sale sites 120_1 to 120_N. In FIG. 1, reference sign 160 indicates an example of the component unit-price information that the component information monitoring apparatus 140 acquires by accessing the sale site 120_1 (site name: “Sale Site A”).

The component information monitoring apparatus 140 analyzes the component unit-price information and the site information of each electronic component, and thereby indirectly monitors a target component in terms of the occurrence of some event or the possibility of some event occurring (the component information). The “event” mentioned herein means any event that may influence the balance between a supply of electronic components by a component maker and a demand for electronic components by users (such for example as an EOL).

When determining that some event concerning the target component has occurred or is likely to occur, the component information monitoring apparatus 140 gives an alarm to the user of the component information monitoring apparatus 140.

In this way, in the component information monitoring system 100, the component information monitoring apparatus 140 analyzes the component unit-price information and the site information of each electronic component repetitively at different time points. The component unit-price information and the site information vary due to influences of various events which occur on each electronic component. For this reason, it is possible to indirectly monitor the component information by analyzing the component unit-price information and the site information.

As a result, the component information monitoring system 100 enables the user to conduct sufficient study for component procurement as to whether stable component supply will be received and thereby makes it possible to reduce a risk in the component procurement.

<Description of Component Information Monitoring Scheme>

Next, description will be given of monitoring schemes of indirectly monitoring a target component in terms of the occurrence of some event or the possibility of some event occurring (the component information) from multiple viewpoints. In the first embodiment, the component information monitoring apparatus 140 uses two methods from multiple viewpoints, namely, ●a monitoring method from a viewpoint of the same series in the same category by the same component maker, and ●a monitoring method from a viewpoint of the same category (including different series) by the same component maker. Hereinafter, an outline of these monitoring schemes will be described.

(1) Monitoring Method from Viewpoint of Same Series in Same Category by Same Component Maker

(1-1) First Event

In the case of monitoring from a viewpoint of the same series of electronic components in the same category by the same component maker, the component information monitoring apparatus 140 is capable of detecting an event such for example as:
An event where a decision of the EOL of a particular series of electronic components in a particular category by a particular component maker results in a decrease in the volume of the series of electronic components supplied to the venders by the component maker;
An event where a high failure rate (return rate) of a particular series of electronic components in a particular category by a particular component maker results in an increase in the stock of the series of electronic components in the venders; and
An event where a high-volume order of a particular series of electronic components in a particular category by a particular component maker results in a shortage of the series of electronic components in a particular vender.

This is because when any of these events (first events) occurs, the venders hold their stock and decide their component unit prices in manners different from each other, so that the component unit-price information and the site information of the series of electronic components by the component maker vary among the sale sites.

(1-2) Monitoring Schemes

In order to monitor the influence of the above-described first event on the component unit-price information and the site information, the component information monitoring apparatus 140 employs, for example, the following monitoring schemes including:
For the same series in the same category by the same component maker, acquiring the component unit price on each sale site, and calculating a standard deviation of component unit prices on respective sale sites;
For the same series in the same category by the same component maker, acquiring the component unit price on each sale site, and calculating a decrease rate;
For the same series in the same category by the same component maker, acquiring out-of-stock information on each sale site, and calculating an out-of-stock rate (to be described in detail later); and
For the same series in the same category by the same component maker, acquiring discount information on each sale site, and calculating a frequency of discount (discount display count).

(1-3) Threshold for Detecting Presence/Absence of Influence

In order to detect whether the above-described first event influences the component unit-price information and the site information, the component information monitoring apparatus 140 determines, for example, the following thresholds.
For the series of electronic components in the category by the component maker on which the first event occurred in the past the unit price on each sale site within a predetermined period immediately before the occurrence of the first event is acquired, and the standard deviation of component unit prices on respective sale sites is calculated. A series-by-series standard deviation threshold is determined based on a change in the standard deviation within the predetermined period immediately before the occurrence.
For the series of electronic components in the category by the component maker on which the first event occurred in the past, the decrease rate on each sale site within a predetermined period immediately before the occurrence of the first event is calculated. A decrease rate threshold is determined by using a significant decrease rate among the calculated decrease rates.
For the series of electronic components in the category by the component maker on which the first event occurred in the past, the out-of-stock rate on a particular sale site within a predetermined period immediately before the occurrence of the first event is calculated. An out-of-stock rate threshold is determined by using a significant out-of-stock rate among the calculated out-of-stock rates.
For the series of electronic components in the category by the component maker on which the first event occurred in the past the discount display count on a particular sale site within a predetermined period immediately before the occurrence of the first event is calculated. A discount display count threshold is determined by using a significant discount display count among the calculated discount display counts.

The thresholds thus determined are used to monitor all of the standard deviations, the decrease rates, the out-of-stock rates, and the discount display counts calculated for each series. This does not apply in the case where the first events occurred on multiple series of electronic components in the past. In this case, the thresholds determined for each of the multiple series of electronic components may be used individually to monitor the standard deviations, the decrease rates, the out-of-stock rates, and the discount display counts calculated for the series of electronic components.

The above monitoring scheme of monitoring the same series of electronic components in the same category by the same component maker is only an example. In another possible example, electronic components are monitored in a manner divided by packaging type, and the threshold is determined for each packaging type.

(2) Monitoring Method from Viewpoint of Same Category by Same Component Maker

(2-1) Second Event

In the case of monitoring from a viewpoint of electronic components in the same category (including different series) by the same component maker, the component information monitoring apparatus 140 is capable of detecting events such for example as:
An event where a decision of the EOL of electronic components in a particular category by a particular component maker (due to a certain factor such as a business reduction) results in a decrease in the volume of electronic components in the category supplied to the venders by the component maker; and
An event where a certain trouble (a production trouble or a transportation trouble (any of troubles including disasters, accidents, and so on)) that occurred in a factory of a particular component maker which produces and ships a particular category results in a temporary decrease in the volume of supplied electronic components in the category.

This is because when any of these second events occurs, the venders hold their stock and decide their component unit prices in manners different from each other, so that the component unit-price information and the site information of the electronic components in the category by the component maker vary among the sale sites.

(2-2) Monitoring Schemes

In order to monitor the influence of the above second event on the component unit-price information, the component information monitoring apparatus 140 employs, for example, the following monitoring scheme.
For all the series in the same category by the same component maker, the unit prices on each sale site are acquired, and a standard deviation of component unit prices on respective sale sites is calculated for each of the series. The average value of the standard deviations calculated for all the series in the same category by the same component maker is calculated.

(2-3) Threshold for Detecting Presence/Absence of Influence

In order to detect whether the above second event influences the component unit-price information, the component information monitoring apparatus 140 determines, for example, the following threshold.

For each of all the series in the category by the component maker on which the second event occurred in the past, the component unit price on each sale site within a predetermined period immediately before the occurrence of the second event is acquired, and a standard deviation of component unit prices on respective sale sites is calculated. A series-by-series standard deviation threshold is calculated first based on a change in the standard deviation of component unit prices on respective sale sites within the predetermined period, and then a category-by-category standard deviation threshold is determined by calculating the average value of the calculated thresholds.

The threshold thus determined is used to monitor all the average values of the standard deviations calculated for each category. This does not apply in the case where the above second events occurred on multiple categories in the past. In this case, the threshold determined for each of the multiple categories of electronic components may be used individually to monitor the average values of the standard deviations calculated for the category of electronic components.

The above monitoring scheme of monitoring the electronic components in the same category by the same component maker is only an example. In another possible example, target sale sites are limited by category, and then the category-by-category standard deviation threshold is determined.

<Hardware Configuration of Component Information Monitoring Apparatus>

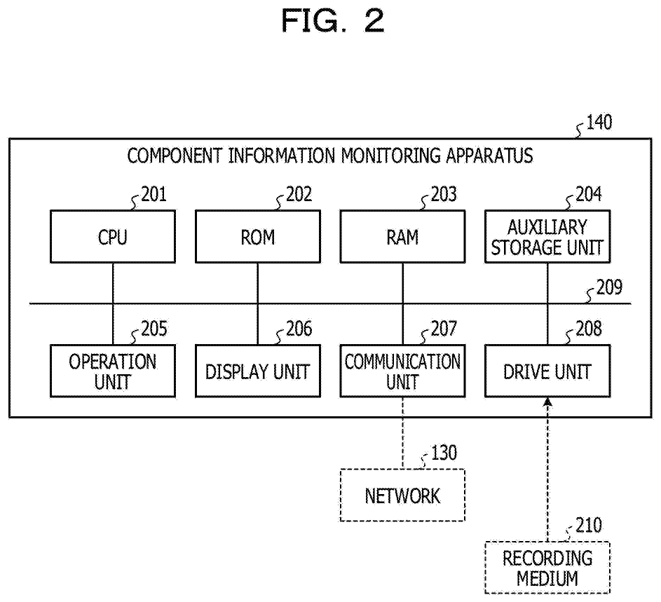

Next, a hardware configuration of the component information monitoring apparatus 140 will be described. FIG. 2 is a diagram illustrating an example of a hardware configuration of a component information monitoring apparatus.

As illustrated in FIG. 2, the component information monitoring apparatus 140 includes a central processing unit (CPU) 201, a read-only memory (ROM) 202, and a random-access memory (RAM) 203. The CPU 201, the ROM 202, and the RAM 203 constitute a so-called computer (information processing apparatus).

The component information monitoring apparatus 140 further includes an auxiliary storage unit 204, an operation unit 205, a display unit 206, a communication unit 207, and a drive unit 208. These hardware components in the component information monitoring apparatus 140 are coupled to each other via a bus 209.

The CPU 201 is an arithmetic device that runs various programs installed in the auxiliary storage unit 204 (such for example as a component information monitoring program to be described later).

The ROM 202 is a non-volatile memory. The ROM 202 functions as a main storage device which stores various programs, data, and so on to be used by the CPU 201 to run the various programs installed in the auxiliary storage unit 204. For example, the ROM 202 functions as a main storage device which stores a boot program and so on such as a basic input/output system (BIOS) and an extensible firmware interface (EFI).

The RAM 203 is a volatile memory such as a dynamic random-access memory (DRAM) or a static random-access memory (SRAM). The RAM 203 functions as a main storage device which provides a work area on which the various programs installed in the auxiliary storage unit 204 are developed for execution by the CPU 201.

The auxiliary storage unit 204 is an auxiliary storage device which stores the various programs and information to be acquired through execution of the various programs. A unit-price information storage unit and a criteria information storage unit to be described later are mounted in the auxiliary storage unit 204.

The operation unit 205 is an input device to be used by the user of the component information monitoring apparatus 140 to input various instructions to the component information monitoring apparatus 140. The display unit 206 is an output device that gives an alarm to the user through execution of the component information monitoring program.

The communication unit 207 is a communication device which is coupled to the network 130 and allows the component information monitoring apparatus 140 to access the sale sites 120_1 to 120_N.

The drive unit 208 is a device in which a recording medium 210 is set. The recording media 210 discussed herein include media which record information optically, electrically, and magnetically like a CD-ROM, a flexible disk, a magneto-optical disk, and so forth. The recording media 210 may also include a semiconductor memory and so on, such as a ROM and a flash memory, which record information electrically.

The various programs installed in the auxiliary storage unit 204 are installed, for example, in such a way that the distributed recording medium 210 is set in the drive unit 208, and the various programs recorded in the recording medium 210 are read by the drive unit 208. Alternatively, the various programs installed in the auxiliary storage unit 204 may be installed by being downloaded from the network 130.

<Functional Configuration of Component Information Monitoring Apparatus>

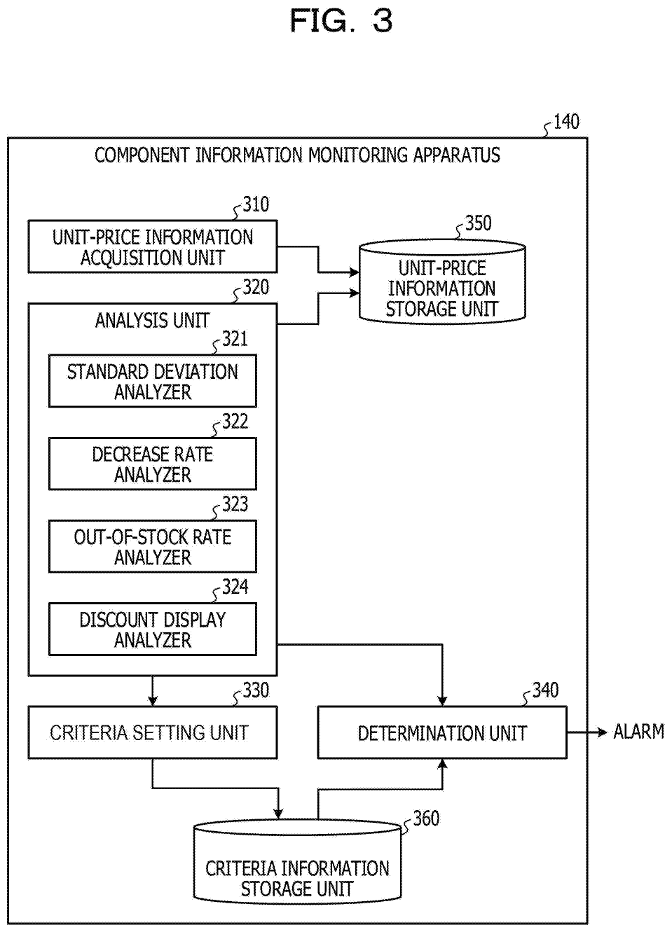

Next, a functional configuration of the component information monitoring apparatus 140 will be described. FIG. 3 is a first diagram illustrating an example of a functional configuration of the component information monitoring apparatus. As described above, the component information monitoring program is installed in the component information monitoring apparatus 140 and the component information monitoring apparatus 140 functions as a unit-price information acquisition unit 310, an analysis unit 320, a criteria setting unit 330, and a determination unit 340 through execution of the program.

The unit-price information acquisition unit 310 is an example of an acquisition unit. The unit-price information acquisition unit 310 accesses the sale sites 120_1 to 120_N repetitively at different time points, and acquires the component unit-price information and the site information from the sale sites 120_1 to 120_N. The unit-price information acquisition unit 310 accumulates the component unit-price information and the site information thus acquired in a unit-price information storage unit 350.

The analysis unit 320 reads the component unit-price information and the site information accumulated in the unit-price information storage unit 350 and performs various analyses thereon. The various analyses performed by the analysis unit 320 include various analyses in a criteria determination phase and various analyses in a component information monitoring phase.

The criteria determination phase is a phase in which prescribed values (thresholds) as criteria in monitoring of the influence of various events on the component unit-price information and the site information are determined based on the component unit-price information and the site information accumulated in the unit-price information storage unit 350.

The component information monitoring phase is a phase in which the influence of various events on the component unit-price information and the site information is monitored based on the component unit-price information and the site information accumulated in the unit-price information storage unit 350 by using the thresholds determined in the criteria determination phase.

As illustrated in FIG. 3, the analysis unit 320 further includes a standard deviation analyzer 321, a decrease rate analyzer 322, an out-of-stock rate analyzer 323, and a discount display analyzer 324.

The standard deviation analyzer 321 calculates the standard deviation of component unit prices on respective sale sites based on the component unit prices on the sale sites, which are accumulated in the unit-price information storage unit 350, for the same series in the same category by the same component maker.

In the criteria determination phase, the standard deviation analyzer 321 notifies the criteria setting unit 330 of a change in the standard deviation of component unit prices on respective sale sites calculated for a predetermined period immediately before the occurrence of each event.

In the component information monitoring phase, the standard deviation analyzer 321 notifies the determination unit 340 of the calculated current standard deviation of component unit prices on respective sale sites.

The decrease rate analyzer 322 calculates the decrease rate based on the component unit prices on the sale sites, which are accumulated in the unit-price information storage unit 350, for the same series in the same category by the same component maker. In the criteria determination phase, the decrease rate analyzer 322 notifies the criteria setting unit 330 of the decrease rate of the component unit price within a predetermined period immediately before the occurrence of each event. In the component information monitoring phase, the decrease rate analyzer 322 notifies the determination unit 340 of the calculated current decrease rate of the component unit price.

The out-of-stock rate analyzer 323 calculates the out-of-stock rate (a proportion at which out-of-stock is displayed) based on the site information of each sale site, which is accumulated in the unit-price information storage unit 350, for the same series in the same category by the same component maker.

In the criteria determination phase, the out-of-stock rate analyzer 323 notifies the criteria setting unit 330 of the out-of-stock rate calculated for a predetermined period immediately before the occurrence of each event. In the component information monitoring phase, the out-of-stock rate analyzer 323 notifies the determination unit 340 of the calculated current out-of-stock rate.

The discount display analyzer 324 analyzes the discount display count based on the site information of each sale site, which is accumulated in the unit-price information storage unit 350, for the same series in the same category by the same component maker.

In the criteria determination phase, the discount display analyzer 324 notifies the criteria setting unit 330 of the discount display count within a predetermined period immediately before the occurrence of each event. In the component information monitoring phase, the discount display analyzer 324 notifies the determination unit 340 of the current discount display count.

The criteria setting unit 330 determines the thresholds for monitoring the influence of each event on the component unit-price information and the site information, based on the analysis results notified of by the analysis unit 320.

For example, based on the change in the standard deviation within the predetermined period immediately before the occurrence of the above-described first event from among the changes in the standard deviations of component unit prices on respective sale sites calculated for the predetermined period immediately before the occurrences of events and notified of by the standard deviation analyzer 321, the criteria setting unit 330 calculates the standard deviation at a middle point between a time point at which the standard deviation starts to increase and a time point at which the standard deviation becomes stable after increase.

The criteria setting unit 330 determines the calculated standard deviation at the middle point as the series-by-series standard deviation threshold.

Based on the changes in the standard deviations (for all the series) within the predetermined period immediately before the occurrence of the above second event from among the changes in the standard deviations of component unit prices on respective sale sites calculated for the predetermined period immediately before the occurrences of the events and notified of by the standard deviation analyzer 321, the criteria setting unit 330 calculates each of the standard deviations for all the series at a middle point between ●a time point at which the standard deviation starts to increase and ●a time point at which the standard deviation becomes stable after increase. The criteria setting unit 330 determines the average value of the standard deviations at the middle points calculated for all the series as the category-by-category standard deviation threshold.

The criteria setting unit 330 analyzes the decrease rate within the predetermined period immediately before the occurrence of the first event from among the decrease rates of the component unit price within the predetermined period immediately before the occurrences of the events notified of by the decrease rate analyzer 322. When finding a significant decrease rate on a particular sale site, the criteria setting unit 330 determines a decrease rate threshold for the particular sale site based on the decrease rate.

The criteria setting unit 330 analyzes the out-of-stock rate within the predetermined period immediately before the occurrence of the first event from among the out-of-stock rates within the predetermined period immediately before the occurrences of the events notified of by the out-of-stock rate analyzer 323. When finding a significant out-of-stock rate on a particular sale site, the criteria setting unit 330 determines an out-of-stock rate threshold for the sale site based on the out-of-stock rate.

The criteria setting unit 330 analyzes the discount display count within the predetermined period immediately before the occurrence of the first event from among the discount display counts within the predetermined period immediately before the occurrences of the events notified of by the discount display analyzer 324. When finding a significant discount display count on a particular sale site, the criteria setting unit 330 determines a discount display count threshold for the sale site based on the discount display count.

The criteria setting unit 330 stores the determined thresholds as criteria information into a criteria information storage unit 360.

The determination unit 340 monitors whether there is an influence of each event on the component unit-price information and the site information based on the analysis results notified of by the analysis unit 320.

For example, the determination unit 340 compares the current standard deviation notified of by the standard deviation analyzer 321 with the series-by-series standard deviation threshold stored in the criteria information storage unit 360. The determination unit 340 determines whether the current standard deviation exceeds the series-by-series standard deviation threshold. When the current standard deviation is determined as exceeding the series-by-series standard deviation threshold as a result of the determination, the determination unit 340 determines that some event concerning the target component has occurred or is likely to occur.

The determination unit 340 calculates the average value of the current standard deviations notified of by the standard deviation analyzer 321 for each category by the same component maker, and compares the calculated average value with the category-by-category standard deviation threshold stored in the criteria information storage unit 360. The determination unit 340 determines whether the calculated average value exceeds the category-by-category standard deviation threshold. When the average value is determined as exceeding the category-by-category standard deviation threshold as a result of the determination, the determination unit 340 determines that some event concerning the target component has occurred or is likely to occur.

The determination unit 340 compares the decrease rate on a particular sale site among the current decrease rates notified of by the decrease rate analyzer 322 with the decrease rate threshold for the particular sale site stored in the criteria information storage unit 360. The determination unit 340 determines whether the current decrease rate on the particular sale site exceeds the decrease rate threshold for the particular sale site. When the decrease rate is determined as exceeding the decrease rate threshold for the particular sale site as a result of the determination, the determination unit 340 determines that some event concerning the target component has occurred or is likely to occur.

The determination unit 340 compares the out-of-stock rate on a particular sale site among the current out-of-stock rates notified of by the out-of-stock rate analyzer 323 with the out-of-stock rate threshold for the particular sale site stored in the criteria information storage unit 360. The determination unit 340 determines whether the current out-of-stock rate on the particular sale site exceeds the out-of-stock rate threshold for the particular sale site. When the out-of-stock is determined as exceeding the out-of-stock rate threshold for the particular sale site as a result of the determination, the determination unit 340 determines that some event concerning the target component has occurred or is likely to occur.

The determination unit 340 compares the discount display count on a particular sale site among the current discount display counts notified of by the discount display analyzer 324 with the discount display count threshold for the particular sale site stored in the criteria information storage unit 360. The determination unit 340 determines whether the current discount display count on the particular sale site exceeds the discount display count threshold for the particular sale site. When the discount display count is determined as exceeding the discount display count threshold for the particular sale site, the determination unit 340 determines that some event concerning the target component has occurred or is likely to occur.

Further, the determination unit 340 gives an alarm to the user when determining that some event concerning the target component has occurred or is likely to occur. This enables the user of the component information monitoring apparatus 140 to recognize that some event concerning the target component has occurred or is likely to occur. Consequently, this enables the user to conduct sufficient study for component procurement as to whether stable component supply will be received, and thereby makes it possible to reduce a risk in the component procurement.

<Description of Component Unit Price and Standard Deviation>

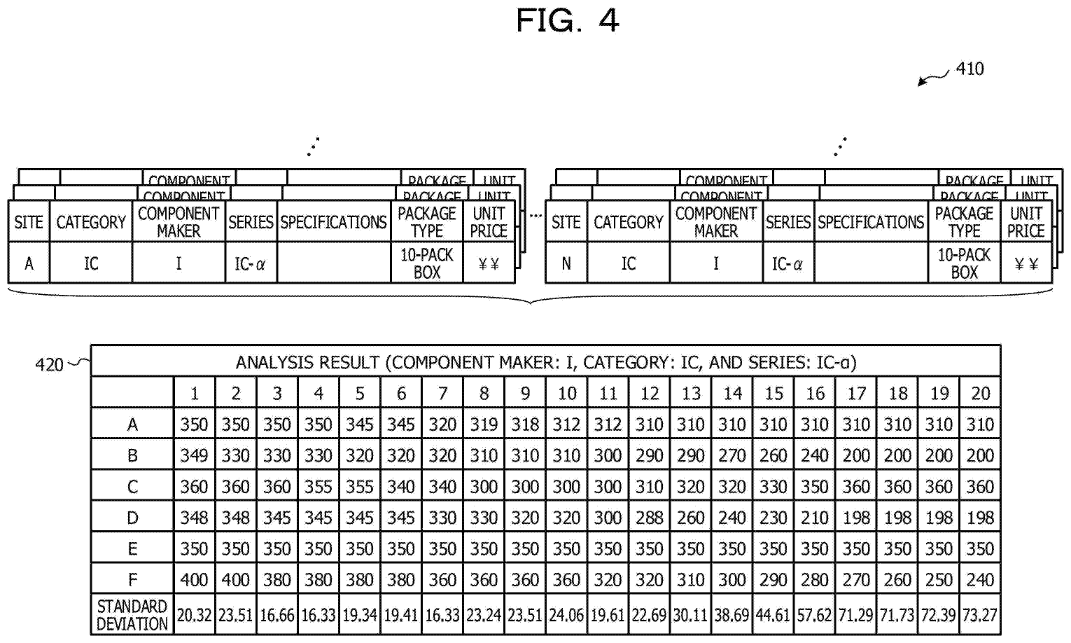

Next, description will be given of a specific example of component unit prices and standard deviations within a predetermined period immediately before the occurrence of an event for the same series in the same category by the same component maker. FIG. 4 is a diagram illustrating a specific example of component unit prices and standard deviations.

In FIG. 4, for ●Category=“IC”, ●Component Maker=“Component Maker I”, ●Series=“IC-o”, and ●Package Type=“10-Pack Box”, component unit-price information 410 indicates component unit prices within a predetermined period immediately before the occurrence of the above-described first event on each of sale sites (“Sale Site A” to “Sale Site N”). The illustration of multiple pieces of the component unit-price information of each sale site in a stack form means that the multiple pieces of the component unit-price information of the sale site are acquired within the predetermined period immediately before the occurrence of the first event (the description is herein given assuming that 20 pieces of the component unit-price information are acquired at different time points).

In FIG. 4, an analysis result 420 presents the standard deviations within the predetermined period immediately before the occurrence of the first event, the standard deviations calculated by the standard deviation analyzer 321 based on the acquired component unit-price information 410. The analysis result 420 only presents the standard deviations calculated based on the component unit prices of the site names=“Sale Site A” to “Sale Site F” due to space limitations.

Thus, in the criteria determination phase, the standard deviation analyzer 321 calculates the standard deviations of component unit prices on respective sale sites within the predetermined period immediately before the occurrence of the first event.

<Example of Determination of Standard Deviation Threshold>

Next, description will be given of an example in which the criteria setting unit 330 determines the series-by-series standard deviation threshold while presenting graphs indicating a change in the component unit price on each sale site and a change in the standard deviation contained in the analysis result 420 presented in FIG. 4.

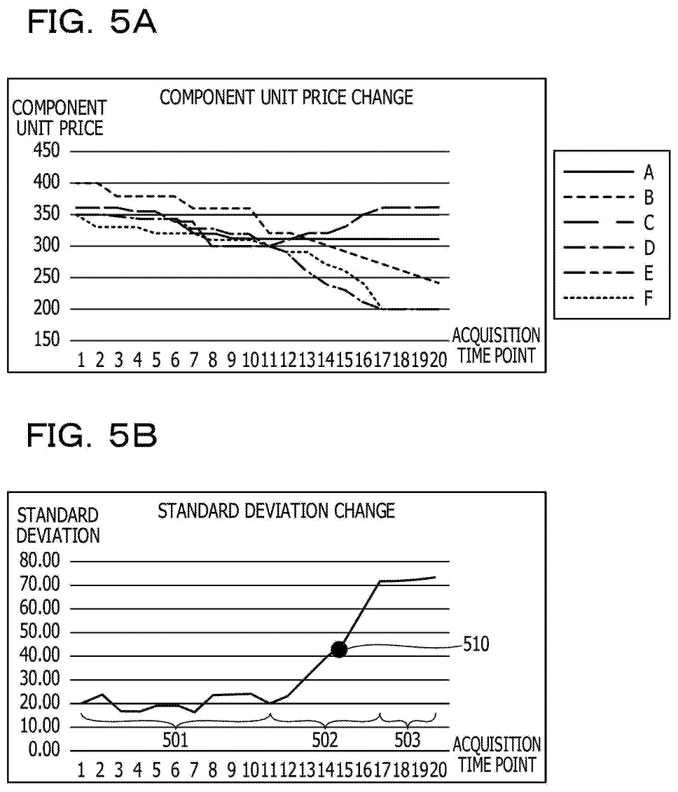

FIGS. 5A and 5B are diagrams illustrating an example of determination of the standard deviation threshold. FIG. 5A is a graph presenting a change in the component unit price on each sale site within the predetermined period including the 20 different time points immediately before the occurrence of the first event contained in the analysis result 420 presented in FIG. 4. In FIG. 5A, the horizontal axis indicates time points at which the component unit-price information 410 is acquired within the predetermined period immediately before the occurrence of the first event, and the vertical axis indicates the component unit price at each acquisition time point. FIG. 5A also only presents the component unit prices on the “Sale Site A” to “Sale Site F”.

Meanwhile, FIG. 5B is a graph of a change in the standard deviation within the predetermined period immediately before the occurrence of the first event contained in the analysis result 420 presented in FIG. 4. In FIG. 5B, the horizontal axis indicates time points at which the component unit-price information 410 is acquired within the predetermined period immediately before the occurrence of the first event, and the vertical axis indicates the standard deviation calculated at each acquisition time point.

In the example of FIG. 5B, the standard deviation mostly lies within a certain range at the first to 11th acquisition time points (see reference sign 501). Then, the standard deviation starts to increase from the 12th acquisition time point and continuously increases until the 17th acquisition time point (see reference sign 502). Thereafter, the standard deviation is continuously and stably high at the 18th to 20th acquisition time points (see reference sign 503).

For such a change in the standard deviation, the criteria setting unit 330 identifies ●the time point at which the standard deviation starts to increase=the 12th point and ●the time point at which the standard deviation becomes stable after increase=the 17th point, and calculates the standard deviation at the middle point between the 12th standard deviation and the 17th standard deviation (see a black circle 510 in FIG. 5B). Then, the criteria setting unit 330 determines the calculated standard deviation at the middle point as the series-by-series standard deviation threshold.

The description is given of the example of determination of the series-by-series threshold with reference to FIGS. 5A and 5B. When the above second event occurs, graphs respectively for all the series in the category by the component maker are generated like the graph presented in FIG. 5B, and the standard deviation at the middle point is calculated from each of the graphs. Thus, the criteria setting unit 330 determines the average value of the standard deviations at the middle points calculated for all the series as the category-by-category standard deviation threshold.

<Example of Determination of Decrease Rate Threshold, Out-of-Stock Rate Threshold, and Discount Display Count Threshold>

Next, description will be given of an example of determination of the decrease rate threshold, the out-of-stock rate threshold, and the discount display count threshold.

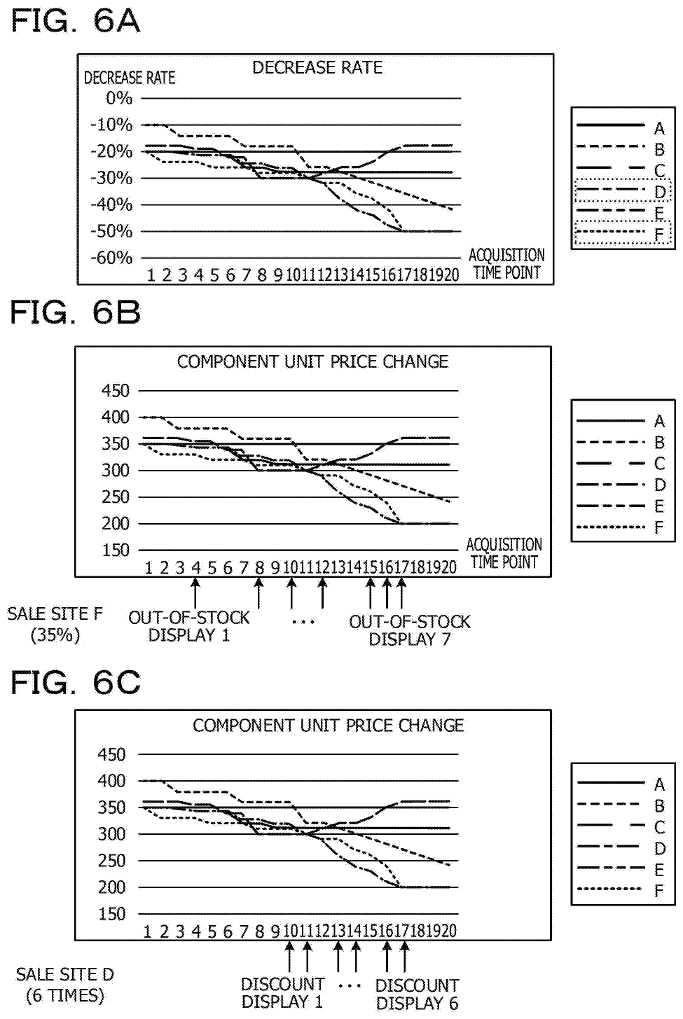

FIGS. 6A to 6C are diagrams illustrating an example of determination of the decrease rate threshold, the out-of-stock rate threshold, and the discount display count threshold. FIG. 6A presents the decrease rates calculated by the decrease rate analyzer 322 based on the component unit prices on each sale site within the predetermined period including the 20 different time points immediately before the occurrence of the first event. In FIG. 6A, the horizontal axis indicates time points at which the component unit-price information 410 is acquired within the predetermined period immediately before the occurrence of the first event, and the vertical axis indicates the decrease rates from the initial component unit price at the respective acquisition time points.

In the case of FIG. 6A, there are sale sites each having a significant decrease rate of the component unit price within the predetermined period immediately before the occurrence of the first event (for example, “Sale Site D” and “Sale Site F”). Thus, the criteria setting unit 330 determines the decrease rate threshold for the sale sites based on the decrease rates of the sale sites.

FIG. 6B presents the out-of-stock rate on a particular sale site (for example, “Sale Site F”) calculated by the out-of-stock rate analyzer 323 based on the site information within the predetermined period immediately before the occurrence of the first event. In FIG. 6B, out-of-stock displays are provided in association with the graph presenting the changes in the component unit price for the sake of convenience. In the case of FIG. 6B, seven out-of-stock displays are provided on the particular sale site (for example, “Sale Site F”) within the predetermined period immediately before the occurrence of the first event (thus, the out-of-stock rate=7/20×100=35%). Thus, the criteria setting unit 330 determines the out-of-stock rate threshold for the particular sale site (for example, “Sale Site F”) based on the significant out-of-stock rate.

FIG. 6C presents the discount display count on a particular sale site (for example, “Sale Site D”) calculated by the discount display analyzer 324 based on the site information within the predetermined period immediately before the occurrence of the first event. In FIG. 6C, discount displays are provided in association with the graph presenting the changes in the component unit price for the sake of convenience. In the case of FIG. 6C, six discount displays are provided on a particular sale site (for example, “Sale Site D”) within the predetermined period immediately before the occurrence of the first event. Thus, the criteria setting unit 330 determines the discount display count threshold for the particular sale site (for example, “Sale Site D”) based on the significant discount display count.

<Description of Criteria Information>

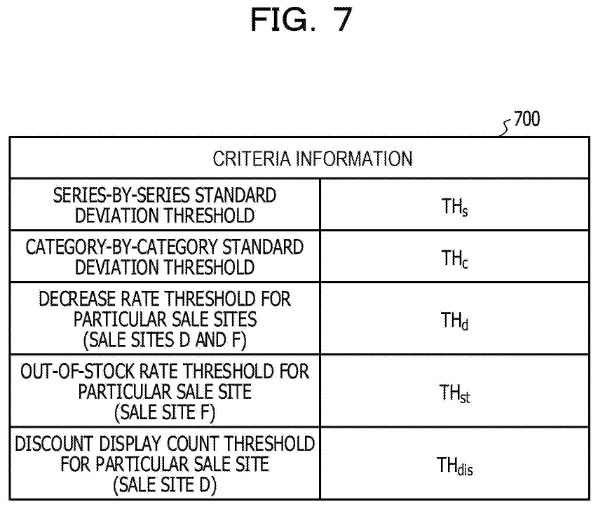

Next, description will be given of the criteria information stored in the criteria information storage unit 360 of the component information monitoring apparatus 140. FIG. 7 is a diagram illustrating an example of the criteria information. As illustrated in FIG. 7, criteria information 700 contains ●the series-by-series standard deviation threshold, ●the category-by-category standard deviation threshold, ●the (series-by-series) decrease rate threshold for a particular sale site, ●the (series-by-series) out-of-stock rate threshold for a particular sale site, and ●the (series-by-series) discount display count threshold for a particular sale site.

In the case of the criteria information 700, only one threshold (“THs”) is stored as the series-by-series standard deviation threshold. In the case where the above-described first events have occurred on multiple series, however, the series-by-series standard deviation thresholds for the respective series are calculated and stored in the criteria information 700.

Similarly, in the case of the criteria information 700, only one threshold (“THc”) is stored as the category-by-category standard deviation threshold. In the case where aforementioned second events have occurred on multiple categories, however, the category-by-category standard deviation thresholds for the respective categories are calculated and stored in the criteria information 700.

The case illustrated as the criteria information 700 is the case where the decrease rate threshold for the sale sites=“Sale Site D” and “Sale Site F” is calculated as the decrease rate threshold for the particular sale sites. However, when a significant decrease rate is also found on a different sale site, the criteria setting unit 330 may calculate the decrease rate threshold for the different sale site.

The case illustrated as the criteria information 700 is the case where the out-of-stock rate threshold for the sale site=“Sale Site F” is calculated as the out-of-stock rate threshold for the particular sale site. However, when a significant out-of-stock rate is also found on a different sale site, the criteria setting unit 330 may calculate the out-of-stock rate threshold for the different sale site.

The case illustrated as the criteria information 700 is the case where the discount display count threshold for the sale site=“Sale Site D” is calculated as the discount display count threshold for the particular sale site. However, when a significant discount display count is also found on a different sale site, the criteria setting unit 330 may calculate the discount display count threshold for the different sale site.

<Example of Analysis Result>

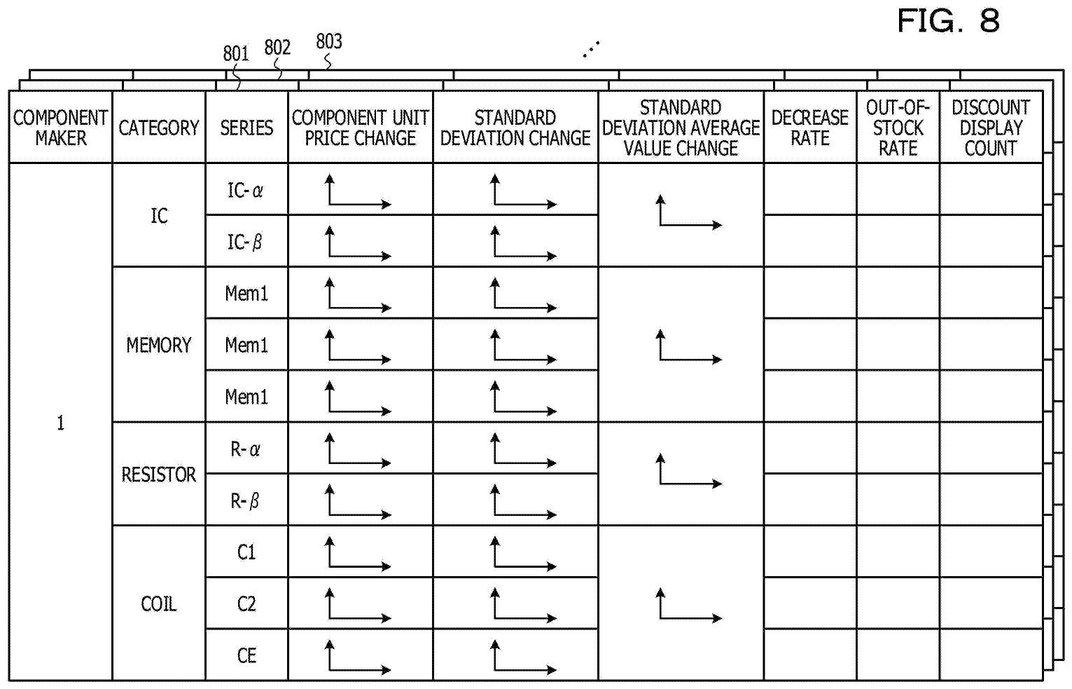

Next, description will be given of an analysis result by the analysis unit 320 in the component information monitoring phase. FIG. 8 is a diagram illustrating an example of analysis results by the analysis unit.

Among them, an analysis result 801 presents a result for a component maker=“Component Maker I” obtained by acquiring and analyzing the component unit-price information and the site information for each series in each category.

As presented in the analysis result 801, the component maker=“Component Maker I” produces categories=“IC”, “memory”, “resistor element”, and “coil element”. The component maker=“Component Maker I” produces two series (“IC-α” and “IC-β”) in the category=“IC”. The component maker=“Component Maker I” produces three series (“Mem1”, “Mem2”, and “Mem3”) in the category=“memory”. The component maker=“Component Maker I” produces two series (“R-a” and “R-p”) in the category=“resistor element”. The component maker=“Component Maker I” produces three series (“C1”, “C2”, and “C3”) in the category=“coil element”.

Under the above circumstances, the standard deviation analyzer 321 acquires the component unit-price information for each series from each sale site, and records it into “component unit price change”. The standard deviation analyzer 321 calculates the standard deviation based on the component unit-price information on the sale sites for each series recorded in the “component unit price change” and records it into “standard deviation change”.

The standard deviation analyzer 321 calculates the average value of the standard deviations recorded in the “standard deviation change” for each category and records it into “standard deviation average value change”.

The decrease rate analyzer 322 calculates the decrease rate on a particular sale site based on the component unit-price information recorded in the “component unit price change” for each series and records it into “decrease rate”.

The out-of-stock rate analyzer 323 acquires the site information for each series from each sale site, calculates the out-Of-stock rate on a particular sale site, and records it into “out-of-stock rate”. The discount display analyzer 324 acquires the site information for each series from each sale site, calculates the discount display count on a particular sale site, and records it into “discount display count”.

An analysis result 802 presents a result for a component maker=“Component Maker II” obtained by acquiring and analyzing the component unit-price information and the site information for each series in each category. An analysis result 803 presents a result for a component maker=“Component Maker III” obtained by acquiring and analyzing the component unit-price information and the site information for each series in each category. Then, the analysis unit 320 outputs analysis results for all the component makers obtained in the same way (not illustrated in FIG. 8).

When notified of each of the analysis results 801 to 803 and so on by the analysis unit 320, the determination unit 340 determines whether some event concerning the target component has occurred or is likely to occur based on the analysis result. For example, the determination unit 340 compares the series-by-series standard deviation threshold THs recorded in the criteria information 700 with the current standard deviation (the standard deviation of a target component) recorded in the “standard deviation change” in each of the analysis results one after another. The determination unit 340 determines whether the current standard deviation recorded in the “standard deviation change” of each analysis result exceeds the series-by-series standard deviation threshold THs.

Subsequently, the determination unit 340 compares the category-by-category standard deviation threshold THc recorded in the criteria information 700 with the current category-by-category standard deviation average value (the standard deviation of the target component) recorded in the “standard deviation average value change” in each of the analysis results one after another. The determination unit 340 determines whether the current category-by-category standard deviation average value recorded in the “standard deviation average value change” of each analysis result exceeds the category-by-category standard deviation threshold THc.

Next, the determination unit 340 compares the decrease rate threshold THd for the particular sale site recorded in the criteria information 700 with the current decrease rate on the particular sale site (the decrease rate of the target component) recorded in the “decrease rate” in each of the analysis results one after another. The determination unit 340 determines whether the current decrease rate on the particular sale site recorded in the “decrease rate” of each analysis result exceeds the decrease rate threshold THd for the particular sale site.

Thereafter, the determination unit 340 compares the out-of-stock rate threshold THst for the particular sale site recorded in the criteria information 700 with the current out-of-stock rate on the particular sale site (the out-of-stock rate of the target component) recorded in the “out-of-stock rate” in each of the analysis results one after another. The determination unit 340 determines whether the current out-of-stock rate on the particular sale site recorded in the “out-of-stock rate” of each analysis result exceeds the out-of-stock rate threshold THst for the particular sale site.

Subsequently, the determination unit 340 compares the discount display count threshold THdis for the particular sale site recorded in the criteria information 700 with the current discount display count on the particular sale site (the discount display count of the target component) recorded in the “discount display count” in each of the analysis results one after another. The determination unit 340 determines whether the current discount display count on the particular sale site recorded in the “discount display count” of each analysis result exceeds the discount display count threshold THdis for the particular sale site.

In this way, the determination unit 340 is capable of monitoring the component information by way of the multiple monitoring schemes.

<Procedure of Criteria Determination Processing>

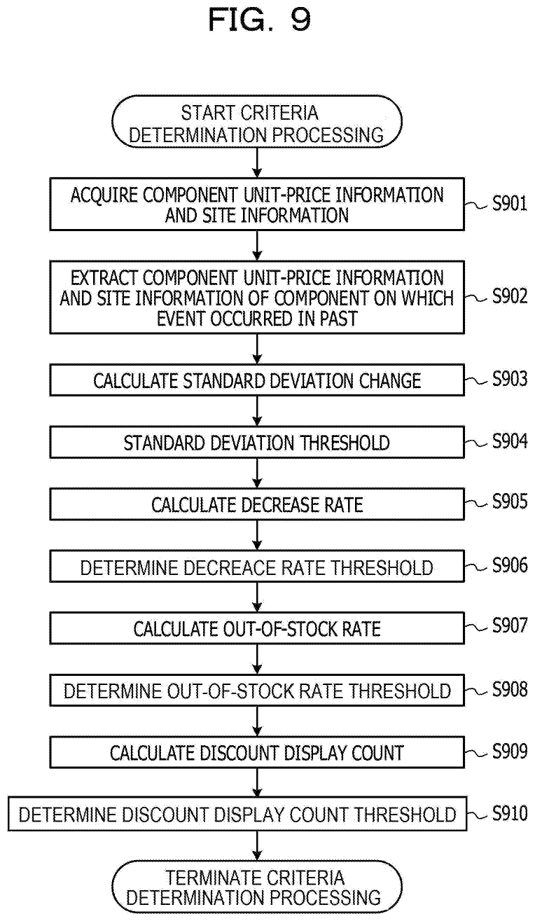

Next, description will be given of a procedure of criteria determination processing executed by the component information monitoring apparatus 140 in the criteria determination phase. FIG. 9 is a flowchart illustrating a procedure of criteria determination processing.

At step S901, the unit-price information acquisition unit 310 accesses the sale sites 120_1 to 120_N repetitively at different time points, acquires the component unit-price information and the site information, and accumulates them in the unit-price information storage unit 350.

At step S902, for an electronic component on which an event occurred in the past, the analysis unit 320 extracts the component unit-price information and the site information within the predetermined period immediately before the occurrence of the event from the component unit-price information and the site information stored in the unit-price information storage unit 350.

At step S903, the standard deviation analyzer 321 calculates the standard deviation change of the component unit price within the predetermined period immediately before the occurrence of the event based on the component unit-price information extracted at step S902.

At step S904, the criteria setting unit 330 calculates the series-by-series standard deviation threshold and the category-by-category standard deviation threshold based on the calculated standard deviation change, and records these thresholds into the criteria information 700.

At step S905, the decrease rate analyzer 322 calculates the decrease rate within the predetermined period immediately before the occurrence of the event based on the component unit-price information extracted at step S902. At step S906, the criteria setting unit 330 determines the decrease rate threshold for the particular sale site, and records this threshold into the criteria information 700.

At step S907, the out-of-stock rate analyzer 323 calculates the out-of-stock rate within the predetermined period immediately before the occurrence of the event based on the site information extracted at step S902. At step S908, the criteria setting unit 330 determines the out-of-stock rate threshold for the particular sale site, and records this threshold into the criteria information 700.

At step S909, the discount display analyzer 324 calculates the discount display count within the predetermined period immediately before the occurrence of the event based on the site information extracted at step S902. At step S910, the criteria setting unit 330 determines the discount display count threshold for the particular sale site based on the calculated discount display count, and records this threshold into the criteria information 700.

<Procedure of Component Information Monitoring Processing>

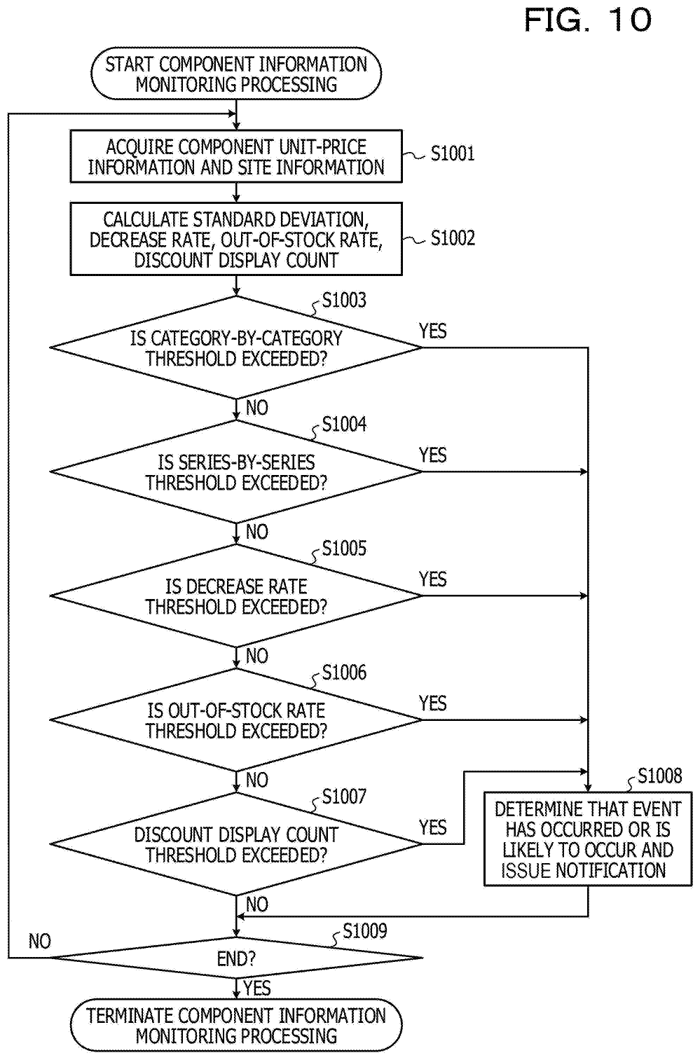

Next, description will be given of a procedure of component information monitoring processing executed by the component information monitoring apparatus 140 in the component information monitoring phase. FIG. 10 is a flowchart illustrating a procedure of component information monitoring processing.

At step S1001, the unit-price information acquisition unit 310 accesses the sale sites 120_1 to 120_N repetitively at different time points, acquires the component unit-price information and the site information, and accumulates them in the unit-price information storage unit 350.

At step S1002, the analysis unit 320 reads the current component unit-price information and site information from the component unit-price information and the site information accumulated in the unit-price information storage unit 350. The analysis unit 320 analyzes the read current component unit-price information and site information. For example, the standard deviation analyzer 321 calculates the current standard deviations (the series-by-series standard deviation and the category-by-category standard deviation average value). The decrease rate analyzer 322 calculates the current decrease rate on the particular sale site. The out-of-stock rate analyzer 323 calculates the current out-of-stock rate on the particular sale site. The discount display analyzer 324 calculates the current discount display count on the particular sale site.

At step S1003, the determination unit 340 reads the category-by-category standard deviation threshold from the criteria information storage unit 360, and compares this threshold with the current category-by-category standard deviation average value calculated at step S1002. When the category-by-category standard deviation average value is determined as exceeding the category-by-category standard deviation threshold as a result of the comparison at step S1003 (Yes at step S1003), the processing advances to step S1008.

On the other hand, when the category-by-category standard deviation average value is determined as not exceeding the category-by-category standard deviation threshold at step S1003 (No at step S1003), the processing advances to step S1004.

At step S1004, the determination unit 340 reads the series-by-series standard deviation threshold from the criteria information storage unit 360, and compares this threshold with the current series-by-series standard deviation calculated at step S1002. When the current series-by-series standard deviation is determined as exceeding the series-by-series standard deviation threshold as a result of the comparison at step S1004 (Yes at step S1004), the processing advances to step S1008.

On the other hand, when the current series-by-series standard deviation is determined as not exceeding the series-by-series standard deviation threshold at step S1004 (No at step S1004), the processing advances to step S1005.

At step S1005, the determination unit 340 reads the decrease rate threshold for the particular sale site from the criteria information storage unit 360, and compares this threshold with the current decrease rate on the particular sale site calculated at step S1002. When the current decrease rate on the particular sale site is determined as exceeding the read decrease rate threshold as a result of the comparison at step S1005 (Yes at step S1005), the processing advances to step S1008.

On the other hand, when the current decrease rate on the particular sale site is determined as not exceeding the read decrease rate threshold at step S1005 (No at step S1005), the processing advances to step S1006.

At step S1006, the determination unit 340 reads the out-of-stock rate threshold for the particular sale site from the criteria information storage unit 360, and compares this threshold with the current out-of-stock rate on the particular sale site calculated at step S1002. When the current out-of-stock rate on the particular sale site is determined as exceeding the read out-of-stock rate threshold as a result of the comparison at step S1006 (Yes at step S1006), the processing advances to step S1008.

On the other hand, when the current out-of-stock rate on the particular sale site is determined as not exceeding the read out-of-stock rate threshold at step S1006 (No at step S1006), the processing advances to step S1007.

At step S1007, the determination unit 340 reads the discount display count threshold for the particular sale site from the criteria information storage unit 360, and compares this threshold with the current discount display count on the particular sale site calculated at step S1002. When the current discount display count on the particular sale site is determined as exceeding the read discount display count threshold as a result of the comparison at step S1007 (Yes at step S1007), the processing advances to step S1008.

At step S1008, the determination unit 340 determines that some event concerning the target component has occurred or is likely to occur and gives an alarm to the user.

On the other hand, when the current discount display count on the particular sale site is determined as not exceeding the read discount display count threshold at step S1007 (No at step S1007), the processing advances to step S1009.

At step S1009, the analysis unit 320 determines whether to terminate the component information monitoring processing, and returns to step S1001 when determining not to terminate the processing (No at step S1009). The analysis unit 320 terminates the component information monitoring processing when determining to terminate the processing at step S1009 (Yes at step S1009).

As is clear from the above description, the component information monitoring apparatus according to the first embodiment acquires a unit price of a component sold on each of a plurality of sale sites, which sell a plurality of components, repetitively at different time points from the plurality of sale sites. The component information monitoring apparatus according to the first embodiment monitors a standard deviation, a decrease rate, an out-of-stock rate, and a discount display count of the unit price of the target component on the sale sites, and gives an alarm to the user when any of them exceeds a corresponding prescribed value.

Thus, the component information monitoring apparatus according to the first embodiment enables the user to recognize that some event concerning a target component has occurred or is likely to occur. Consequently, this enables the user conduct sufficient study for component procurement as to whether stable component supply will be received, and thereby makes it possible to reduce a risk in the component procurement.

### Second Embodiment

The above first embodiment has been described as the apparatus using the standard deviation, the decrease rate, the out-of-stock rate, and the discount display count as the multiple monitoring schemes. However, the monitoring schemes used to monitor the component information are not limited to the standard deviation, the decrease rate, the out-of-stock rate, and the discount display count. For example, a variation amount of the standard deviation (standard deviation variation amount) may be used to monitor the component information. Hereinafter, a second embodiment will be described by focusing on a difference from the above first embodiment.

<Functional Configuration of Component Information Monitoring Apparatus>

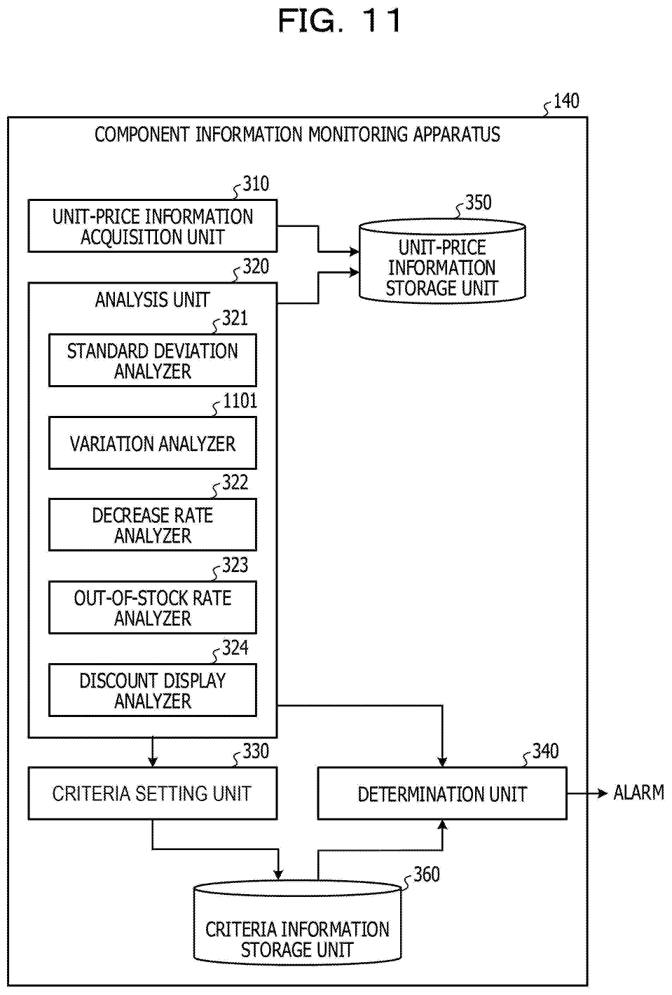

FIG. 11 is a second diagram illustrating an example of a functional configuration of the component information monitoring apparatus. A difference from FIG. 3 is that the analysis unit 320 includes a variation analyzer 1101.

The variation analyzer 1101 acquires the standard deviations calculated by the standard deviation analyzer 321, and calculates a standard deviation variation amount. When the variation amount calculated by the variation analyzer 1101 is equal to or more than a prescribed threshold, the determination unit 340 determines that some event concerning the target component has occurred or is likely to occur, and gives an alarm to the user.

<Analysis Result by Variation Analyzer>

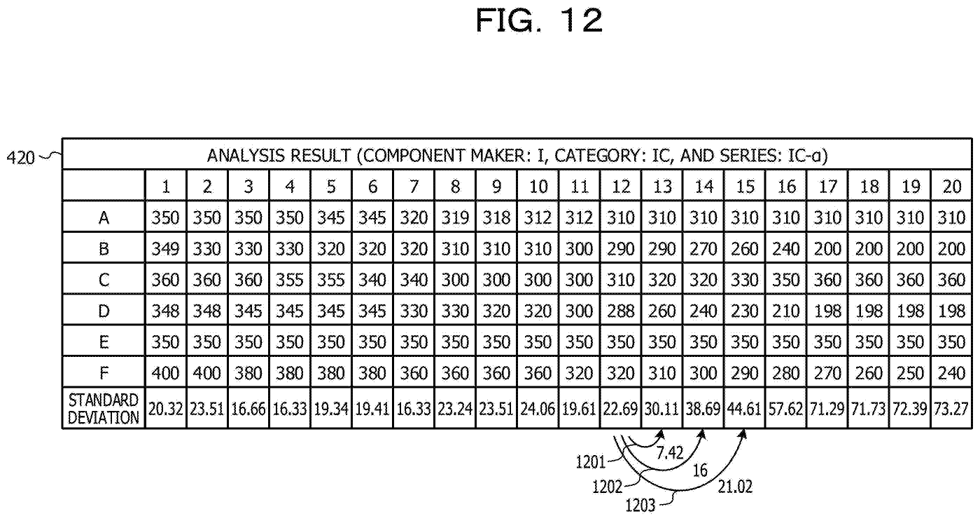

FIG. 12 is a diagram illustrating an example of standard deviation variation amounts. In FIG. 12, an analysis result 420 presents the standard deviations within the predetermined period immediately before the occurrence of the first event calculated by the standard deviation analyzer 321, and is the same as that in FIG. 4.

On the other hand, in FIG. 12, arrows 1201 to 1203 indicate standard deviation variation amounts calculated by the variation analyzer 1101. The arrow 1201 indicates that the standard deviation variation amount from the 12th acquisition time point to the 13th acquisition time point is “7.42”. The arrow 1202 indicates that the standard deviation variation amount from the 12th acquisition time point to the 14th acquisition time point is “16”. The arrow 1203 indicates that the standard deviation variation amount from the 12th acquisition time point to the 15th acquisition time point is “21.02”.

When the standard deviation variation amount of a target component becomes equal to or more than, for example, “15”, the determination unit 340 determines that some event concerning the target component has occurred or is likely to occur and gives an alarm to the user.

In this way, in addition to the functions of the component information monitoring apparatus according to the above first embodiment, the component information monitoring apparatus according to the second embodiment monitors the component information by further using the standard deviation variation amount and gives an alarm to the user when the standard deviation variation amount becomes equal to or more than the predetermined threshold.

Thus, the component information monitoring apparatus according to the second embodiment makes it possible to further reduce a risk in the component procurement.

### Third Embodiment

The above second embodiment has been described as the apparatus using the standard deviation, the standard deviation variation amount, the decrease rate, the out-of-stock rate, and the discount display count as the multiple monitoring schemes. However, the monitoring schemes used to monitor the component information are not limited to the standard deviation, the standard deviation variation amount, the decrease rate, the out-of-stock rate, and the discount display count. For example, whether the component unit price rises or not and a variation amount of the decrease rate (decrease rate variation amount) may be used to monitor the component information. Hereinafter, a third embodiment will be described by focusing on a difference from the above second embodiment.

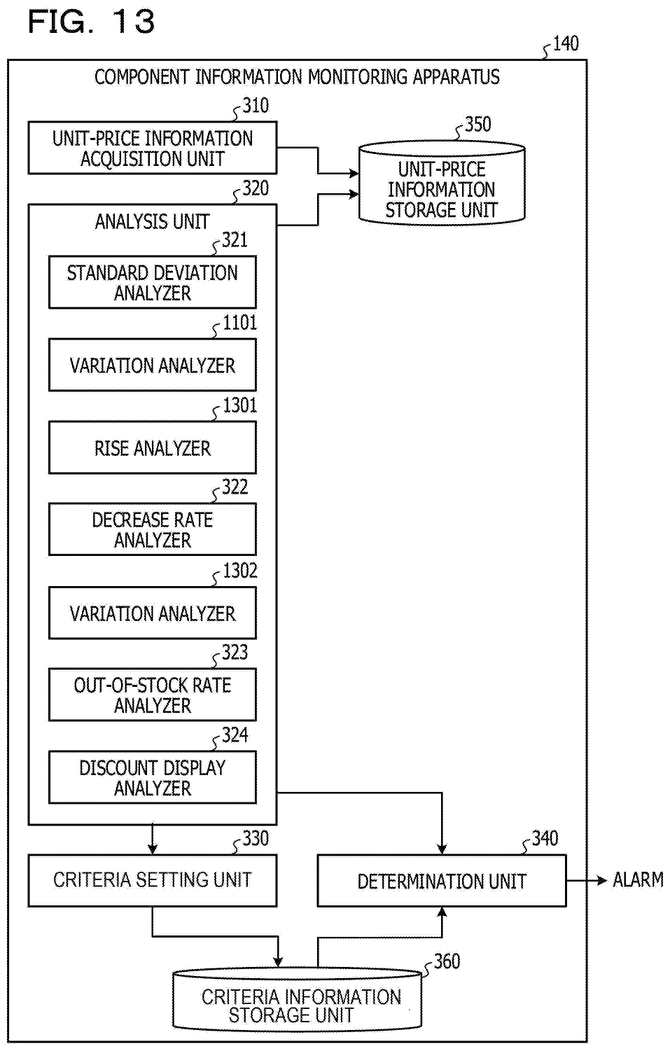

FIG. 13 is a third diagram illustrating an example of a functional configuration of the component information monitoring apparatus. A difference from FIG. 11 is that the analysis unit 320 includes a rise analyzer 1301 and a variation analyzer 1302.

The rise analyzer 1301 analyzes whether the component unit price rises or not, and notifies the determination unit 340 of the analysis result. Thus, when the unit price of a target component rises, the determination unit 340 determines that some event concerning the target component has occurred or is likely to occur and gives an alarm to the user. This is because it is rare that the component unit price rises.

The variation analyzer 1302 analyzes the decrease rate variation amount and notifies the determination unit 340 of the analysis result. Thus, when the variation amount notified of for a target component is equal to or more than a prescribed threshold, the determination unit 340 determines that some event concerning the target component has occurred or is likely to occur, and gives an alarm to the user. This is because it is usual that the component unit price gradually decreases.

In this way, in addition to the functions of the component information monitoring apparatus according to the above second embodiment, the component information monitoring apparatus according to the third embodiment monitors the component information by further using the component unit price rise and the decrease rate variation amount, and gives an alarm to the user.

Thus, the component information monitoring apparatus according to the third embodiment makes it possible to further reduce a risk in the component procurement.

### Other Embodiments

In the above embodiments, the details of the alarm given to the user have not been described. For example, the alarm given to the user may explicitly inform the user about which of the monitoring schemes was used to make the determination. For example, when the determination was made based on the series-by-series standard deviation threshold, a notification that the target component in the series has a high possibility of EOL may be issued as an alarm. Instead, when the determination was made based on the category-by-category standard deviation threshold, a notification that the target component in the category has a high possibility of EOL may be issued as an alarm.

Alternatively, when the determination was made based on the decrease rate threshold for the particular sale site, a notification that the decrease rate of the component unit price on the particular sale site increases may be issued as an alarm. When the determination was made based on the out-of-stock rate threshold for the particular sale site, a notification that the out-of-stock rate of an electronic component on the particular sale site increases may be issued as an alarm. Instead, when the determination was made based on the discount display count threshold for the particular sale site, a notification that the discount display count on the particular sale site increases may be issued as an alarm. In addition, notifications of events such as an increase in the standard deviation variation amount of the component unit price, a rise in the component unit price, and an increase in the decrease rate variation amount of the component unit price may be issued as alarms.

The above embodiments have been described as the apparatus giving an alarm to the user at a timing when any of the thresholds determined by the criteria setting unit is exceeded. However, the timing for giving an alarm is not limited to this. For example, in the case where the user searches for any of electronic components and it was determined in the past that some event concerning the electronic component had occurred or was likely to occur, an alarm may be given at the timing when the electronic component is searched for.

The above embodiments have been described in which the standard deviation from among the multiple monitoring schemes (the standard deviation, the standard deviation variation amount, the component unit price rise, the decrease rate, the decrease rate variation amount, the out-of-stock rate, and the discount display count) is monitored from the series-by-series viewpoint and the category-by-category viewpoint. However, the monitoring using any of the monitoring schemes other than the standard deviation may be conducted from the series-by-series viewpoint and the category-by-category viewpoint. Instead, the monitoring may be conducted from a packaging type-by-packaging type viewpoint.

According to an aspect of the embodiments, a risk in the component procurement may be reduce.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
acquiring, from a plurality of sites which sell a plurality of components, a unit price of a component sold on each of the plurality of sites repetitively at different time points; and
issuing a notification when a standard deviation of respective unit prices of a target component on the plurality of sites exceeds a first prescribed value.

2. The non-transitory computer-readable recording medium according to claim 1, wherein
the first prescribed value is calculated based on a first standard deviation of respective unit prices of a first component, on which an end of life (EOL) has occurred in past, at a middle point between a point before variation in the first standard deviation and a point after the variation, the respective unit prices of the first component having been accumulated within a predetermined period from the plurality of sites.

3. The non-transitory computer-readable recording medium according to claim 1, the process further comprising:
issuing a notification when a decrease rate of the unit price of the target component on a particular site exceeds a second prescribed value.

4. The non-transitory computer-readable recording medium according to claim 1, the process further comprising:
issuing a notification when a proportion at which information indicating that the target component is out of stock is displayed on a particular site exceeds a third prescribed value.

5. The non-transitory computer-readable recording medium according to claim 1, the process further comprising:
issuing a notification when a frequency of discount on the target component on a particular site exceeds a fourth prescribed value.

6. The non-transitory computer-readable recording medium according to claim 1, wherein
the first prescribed value is determined for each category of the plurality of components or for each series of the plurality of components.

7. The non-transitory computer-readable recording medium according to claim 2, wherein the notification indicates a likelihood of EOL.

8. The non-transitory computer-readable recording medium according to claim 1, the process further comprising:
issuing a notification when a variation amount of the standard deviation exceeds a fifth prescribed value.

9. The non-transitory computer-readable recording medium according to claim 1, the process further comprising:
issuing a notification when the unit price of the target component on any of the plurality of sites rises.

10. The non-transitory computer-readable recording medium according to claim 1, the process further comprising:
issuing a notification when a variation amount of a decrease rate of the unit price of the target component on any of the plurality of sites exceeds a sixth prescribed value.

11. An information processing apparatus, comprising:
a memory; and
a processor coupled to the memory and the processor configured to:
acquire, from a plurality of sites which sell a plurality of components, a unit price of a component sold on each of the plurality of sites repetitively at different time points; and
issue a notification when a standard deviation of respective unit prices of a target component on the plurality of sites exceeds a first prescribed value.

12. A method of monitoring component information, the method comprising:
acquiring by a computer, from a plurality of sites which sell a plurality of components, a unit price of a component sold on each of the plurality of sites repetitively at different time points; and
issuing a notification when a standard deviation of respective unit prices of a target component on the plurality of sites exceeds a first prescribed value.
